(19) United States
(12) Patent Application Publication
(10) Pub. No.: US 2010/0002230 A1
(43) Pub. Date: Jan. 7, 2010

(54) APPARATUS FOR MEASURING LIGHT PROCEEDING BACKWARD WITH PLASMONIC DEVICE

(75) Inventor: Jae Won Hahn, Seoul (KR)

Correspondence Address: VENABLE LLP, P.O. BOX 34385, WASHINGTON, DC, 20043-9998, US

(73) Assignee: Industry-Academic Cooperation Foundation, Yonsei University, Seoul (KR)

(21) Appl. No.: 12/325,451

(22) Filed: Dec. 1, 2008

(30) Foreign Application Priority Data
Jul. 2, 2008 (KR) 10-2008-0063985

(51) Int. Cl. G01J 4/00

(52) U.S. Cl. 356/364

(57) ABSTRACT

An apparatus for measuring light proceeding backward to which a plasmonic device is applied is disclosed. A disclosed optical apparatus according to the present invention includes: a plasmonic device including a thin metal film having apertures having a nano-sized diameter, disposed close to an object, and generating a near field in front of the apertures; a polarization modulation unit for adjusting the polarized state of light entering through the apertures of the plasmonic device, and making the light reflecting the strength of the near field proceed backward through the nano-apertures of the plasmonic device, and a measuring unit detecting properties of the object from the light proceeding backward from the polarization modulation unit.

### CROSS-REFERENCES TO RELATED APPLICATION

The present application claims priority under 35 U.S.C. §119(a) to Korean application number 10-2008-0063985, filed on Jul. 2, 2008, in the Korean Intellectual Property Office, which is incorporated herein by reference in its entirety as set forth in full.

### BACKGROUND OF THE INVENTION

1. Technical Field

The present invention relates to an optical apparatus, and more particularly, an apparatus for measuring light proceeding backward which includes a plasmonic device.

2. Related Art

Currently, optical apparatuses are being required to focus light below a diffraction limit of a light source. In compliance with this request, researches on object measuring, light information storing, and micro-pattern forming using apertures whose diameters are several to several tens of nanometers (hereinafter, referred to as nano-apertures) are actively progressing. Light having passed through a nano-aperture is superior than light from a general light source in resolution and focal depth aspects, and researches on techniques for focusing light on a small space and techniques for improving transmittance continues to be conducted.

In particular, a plasmonic device in which nano-apertures are formed in a metal and which causes a plasmon phenomenon is known for realizing a high transmittance and a high resolution.

The plasmonic device includes a thin metal film 10 having nano-apertures 15 formed therein as shown in FIG. 1. If the size of a nano-aperture becomes smaller than the wavelength of light, optical transmittance is reduced and a near field is formed over the nano-aperture. Further, a surface plasmon wave formed on the thin metal film is combined with the near field, which makes light strongly focused into a nano-size or less. The focused near field light exists within 100 nm in front of the aperture. In this state, if an object substrate 20 approaches within 100 nm or less in the front of the aperture, the characteristics of light reflected to the rear of the aperture vary on the basis of the physical characteristics of the object substrate, for example, a nano structure, a dielectric constant, the kind of the object substrate, and a light transmission characteristic and a light focusing characteristic according to the distance between the object substrate and the aperture.

This principle can be applied to measurement equipment for testing the physical characteristics of the object substrate 20 with a high space resolution by using a plasmonic device.

However, since a plasmonic device has a nano-aperture 15 as described above, it is not easy for reflected light (scattered light or fluorescent light) produced by interaction between the object 20 and a near field 30 generated by the plasmonic device to pass through the nano-aperture again and be transmitted to a light receiving unit (not shown) of measurement equipment. Since it is difficult to transmit light to the light receiving unit through the nano-aperture in the measurement equipment including the plasmonic device, a special light pick-up device for directly detecting light scattered from the object 20 is separately provided in the vicinity of the object 20 to detect the physical characteristics of the object 20 by the pick-up device. Since a measurement apparatus according to the related art needs a special device for picking up scattered light, it is difficult to miniaturize a measurement apparatus.

Further, since an optical apparatus (measurement equipment) as described above can perform measuring only when an object substrate 20 performs scattering, it is difficult to measure the characteristics of an object material having a strong absorption characteristic.

### SUMMARY OF THE INVENTION

According to an aspect of the invention, an apparatus for measuring light proceeding backward includes: a plasmonic device including a thin metal film having aperture(s) having a nano-sized diameter, disposed close to an object, and generating a near field in front of the aperture(s); a polarization modulation unit adjusting the polarized state of light entering through the aperture(s) of the plasmonic device, and making the light proceed into the rear of the nano-aperture(s) of the plasmonic device, and a measuring unit detecting the characteristics of the object from the light proceeding backward from the polarization modulation unit.

According to another aspect of the invention, an apparatus for measuring light proceeding backward includes: a polarization modulation unit adjusting the polarized state of light entering a plasmonic device, and making light reflected from nano-apertures proceed backward; and a measuring unit detecting the characteristics of an information recoding medium from the light proceeding backward from the polarization modulation unit. In this apparatus, the information recoding medium includes a built-in plasmonic device composed of a thin metal film having aperture(s) having a nano-sized diameter formed therein.

### BRIEF DESCRIPTION OF THE DRAWINGS

FIG. 1 is a sectional view illustrating a general plasmonic device.

FIG. 2 is a schematic diagram illustrating an apparatus for measuring light proceeding backward to which a plasmonic device according to an embodiment of the invention.

FIGS. 3 and 4 are sectional views illustrating examples of the plasmonic device applied to FIG. 2.

FIGS. 5 and 6 are sectional views illustrating examples of an object substrate applicable to FIG. 2.

FIGS. 7 and 8 are schematic diagrams illustrating apparatuses for measuring light proceeding backward to which a plasmonic device according to other embodiments of the invention.

FIG. 9 is a schematic diagram illustrating a recoding medium having a built-in plasmonic device according to another embodiment of the invention.

FIG. 10 is a schematic diagram illustrating an apparatus for measuring light proceeding backward of the recoding medium of FIG. 9.

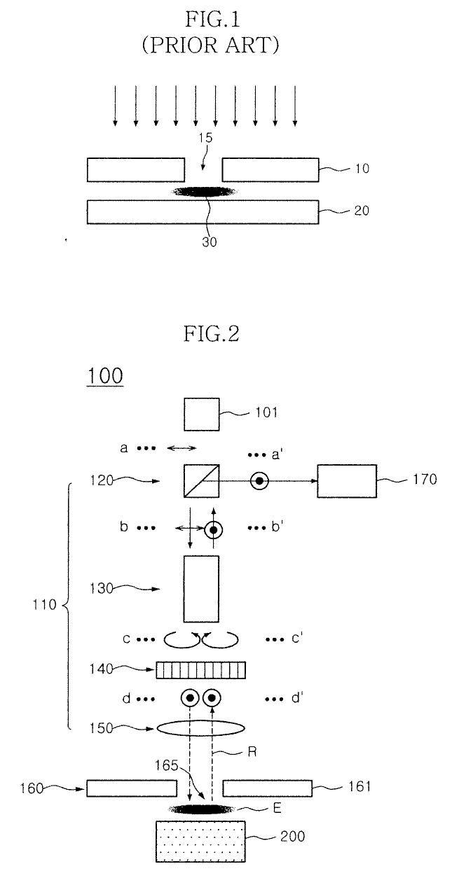

### DESCRIPTION OF EXEMPLARY EMBODIMENT

Hereinafter, exemplary embodiments of the invention will be described with reference to the accompanying drawings.

Embodiments will measure the physical characteristics of an object from light proceeding into the rear of a nano-aperture of a plasmonic device by considering a point that the strength of an electric field generated over the nano-aperture according to the physical characteristics of the object, that is, a near field is variable and a point that light proceeds backward through the nano-aperture when it is coincident with the polarized state of incident light.

This will be described below in detail.

First, referring to FIG. 2, an optical apparatus 100 according to an embodiment can include a light source 101, a polarization modulation unit 110, a plasmonic device 160, and a measuring unit 170.

The polarization modulation unit 110 can be configured to modulate the polarized state of incident light once or more. The polarization modulation unit 110 can include a polarized beam splitter 120, a Faraday rotator 130, a phase delay unit 140, and a condensing lens 150. The polarized beam splitter 120 performs linear polarization, for example, horizontal polarization (P polarization) on incident light. The Faraday rotator 130 and the phase delay unit 140 each delays the phase of incident light by a quarter of a wavelength. The condensing lens 150 condenses the light having passed through the phase delay unit 140 into the plasmonic device 160.

The plasmonic device 160 can include a thin metal film 161 having a nano-aperture 165 smaller than the wavelength of the incident light. The thin metal film 161 can be opaque corresponding to the incident light. For example, the thin metal film 161 can be used an aluminum film (Al) when the wavelength of the incident light is about 400 nm and the thin metal film 161 can be used a gold (Au) when the wavelength of the incident light is about 600 nm. A thickness of the thin metal film 161 can be about 50 nm to about 200 nm.

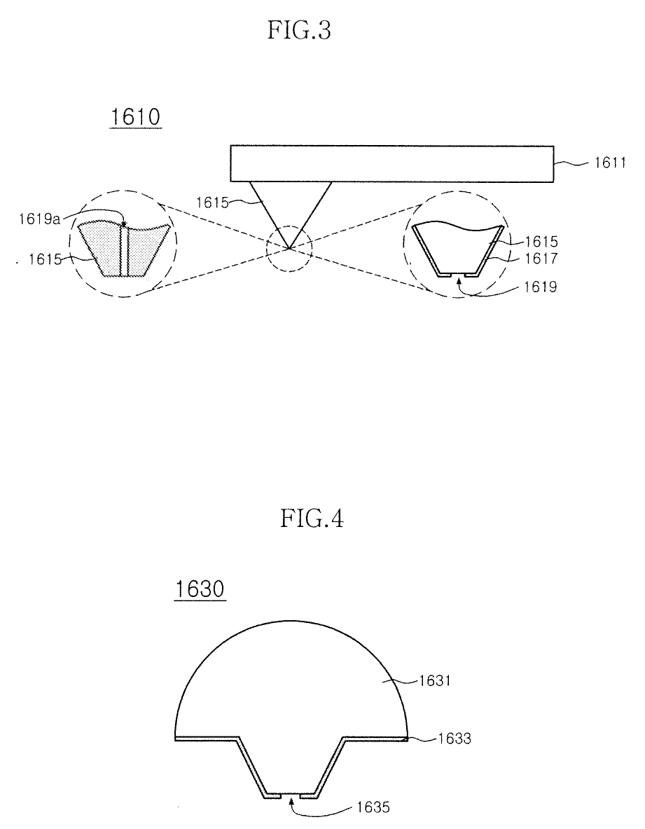

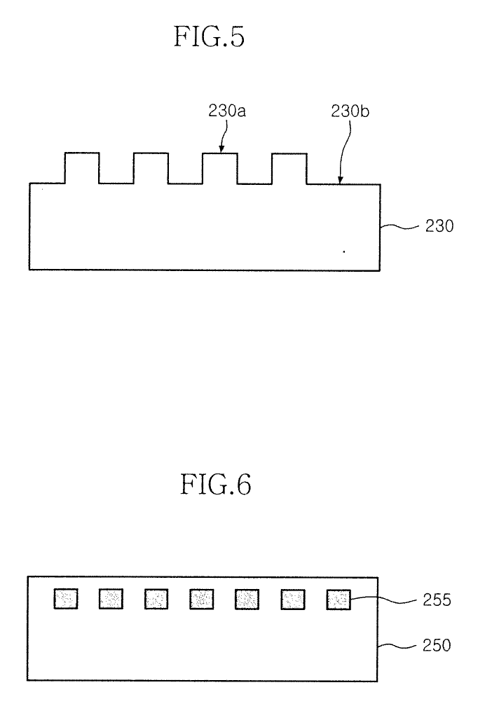

The plasmonic device 160 can be formed of a nano-probe structure as shown in FIG. 3. The nano probe structure 1610 may includes a cantilever 1611 and a nano-probe 1615 attached to the bottom of the cantilever 1611. The nano-probe 1615 can be formed of an optically transparent material and an entire surface of the nano-probe 1615 may be coated with a thin metal film 1617 which has a nano-aperture 1619 for exposing the tip portion of the nano-probe 1615 (refer to an enlarged portion on the right side of FIG. 3). Further, the nano-probe 1615 can be formed of a metal or a semiconductor and have a nano-aperture 1619a to propagate light at the tip portion (refer to an enlarged portion on the left side of FIG. 3). Owing to this configuration, a near field can be generated in the vicinity of the tip of the nano-probe 1615 by a plasmonic phenomenon.

Further, the plasmonic device 160 may be formed of a single lens structure 1630 as shown in FIG. 4. The single lens structure 1630 may be hemispherical, and can include a lens 1631 which has a cone-shaped protrusion and is provided at the flat surface thereof and a thin metal film 1633 which has an aperture to expose the center of the top of the protraction and is provided on the surface of the protraction and the flat surface.

A measurement object substrate 200 (that is, a measurement object material) is disposed within an area, where a near field has been generated by the nano-aperture, in front of the plasmonic device 160.

The measuring unit 170 receives light emitted from the polarization modulation unit 110 and measures the physical characteristics of the object under test 200. The measuring unit 170 can be a light receiving unit built in a general optical apparatus. Further, in this embodiment, the term “reflection” can be understood as it includes not only general reflection from a material surface but also cases in which light proceeds backward such as scattering and diffraction. The measuring unit 170 measures the physical characteristics of the object under test 200 from the intensity of light proceeding into the rear of the nano-probe without providing an additional apparatus for collecting light scattered at the side surface of the nano-probe and analyzing the components of the light.

Specifically, when the object under test 200 is disposed in front of the plasmonic device 160, that is, the nano-aperture 165, the distribution of an electric field (near field E) formed in front of the nano-aperture 165 varies according to the dielectric constant of the object 200, the distance between the object 200 and the plasmonic device 160, and a change in the surface structure of the object 200. The varied distribution of the electric field (near field E) influences the intensity of light reflected into the rear of the nano-aperture. The distribution of the near field can vary according to the polarized state of light entering the nano-aperture. The light proceeding into the rear of the nano-aperture 165 (that is, toward the light source) is obtained from the distribution of the electric field varying according to the state of the object 200 located in front of the nano-aperture. Therefore, the state and characteristics of the object under test 200 can be measured and analyzed by measuring the reflectance of the light proceeding backward, that is, the intensity of the light. In this embodiment, the incident light is polarized from the polarization modulation unit 110 so that light representing the distribution of the electric field (E) easily passes through the nano-aperture.

In this case, it is important to dispose the object under test 200 close to the plasmonic device 160 so that a near field generated on the surface of the object 200. In this embodiment, the object under test 200 is disposed so that the distance between the object under test 200 and the plasmonic device 160 is 100 nm or less.

The optical apparatus 100 is driven in the following manner.

First, light (a) provided from the light source 101 enters the polarization modulation unit 110 which filters the light to obtain horizontally polarized light (b). The horizontally polarized light (b) having passed through the polarization modulation unit 110 passes through the Faraday rotator 130 to be delayed by a quarter of the wavelength, thereby becoming left circular polarized light (c). Here, the left circular polarized light (c) means that the electric field of the light rotates clockwise as it proceeds. The left circular polarized light (c) passes through the phase delay unit 140 to be delayed by a quarter of the wavelength again, thereby becoming vertically polarized light (d). Here, the vertically polarized light means light having a polarized state perpendicular to the horizontally polarized light, that is, an S polarized state. The vertically polarized light (d) is focused by the condensing lens 150 and then enters the nano-aperture 165 of the plasmonic device 160.

Then, a near field (E) reflecting the state and characteristics of the object under test 200 is generated in front of the nano-aperture 165 of the plasmonic device 160. In this case, it is known that the near field (E) depends on the polarization characteristic of the light. If the structure of the nano-aperture 165 and the linear polarized light matches, the plasmon is formed better, and the strength of the near field is thus improved. In this embodiment, since the vertically polarized light passes through the nano-aperture 165 extending vertically, the strength of the near field is further improved.

The light (R) reflected or scattered at the nano-aperture and proceeding backward reflects the physical characteristics of the object under test 200 (such as a refractive index, a dielectric constant, an absorption rate, and a surface characteristic). Next, vertically polarized light (d′) passes through the condensing lens 150 and passes through the phase delay unit 140 having a function of delaying light by a quarter of the wavelength, thereby becoming right circular polarized light (c′). The right circular polarized light (c′) passes through the Faraday rotator 130 to be delayed by a quarter of the wavelength, becoming vertically polarized light (b′) having the same polarized state as light reflected at the nano-aperture. The vertically polarized light (b′) is transmitted to the measuring unit 170 through the polarization modulation unit 110. The measuring unit 170 analyzes the intensity and form of the reflected vertically polarized light (b′) to measure the physical characteristics of the object under test 200.

An example of the object under test 200 may be a substrate 230 having convex portions 230a and concave portions 230b in the surface. Refractive indexes at the convex portions 230a and the concave portions 230b may be different from each other, which changes the characteristics of the near field formed by the nano-aperture. Therefore, the intensity of the light proceeding backward at the nano-aperture varies according to the state of the object under test 200 and the light proceeding backward is collected by the measuring unit 170 and is measured, whereby the physical characteristics, that is, form of the surface of the object under test 200 can be detected.

Another example of the object under test 200 may be an information recording medium 250 having buried information layers 255. The optical characteristics of light reflected from a portion having a buried information layer 255 and a portion having no information layer of the information recording medium 250 are different. Therefore, the measuring unit 170 can detect the positions of the buried information layers 255 from the light reflected from the individual portions.

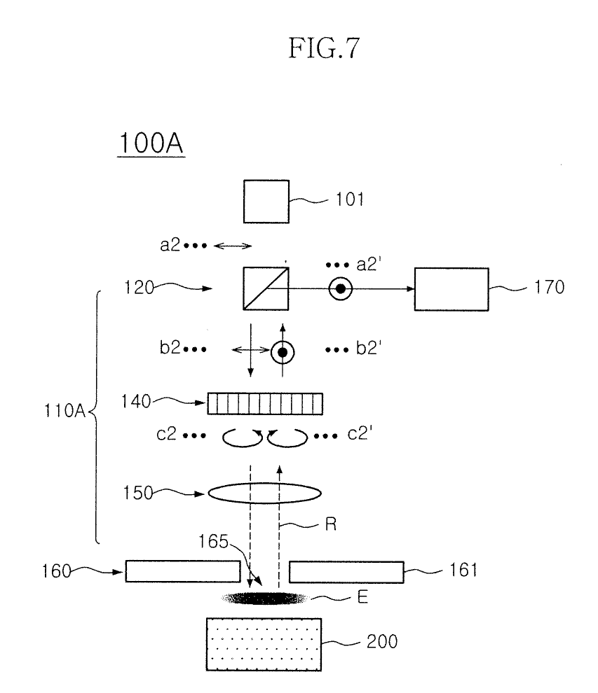

A polarization modulation unit 110A of a measuring apparatus 100A according to another embodiment can include a beam splitter 120, a phase delay unit 140, and a condensing lens 150 as shown in FIG. 7.

In a case where the polarization modulation unit 110A is configured as described above, light (a2) provided from the light source 101 passes through the light division unit 120, thereby becoming vertically polarized light (b2). The vertically polarized light (b2) passes through the phase delay unit 140 to be delayed by a half of the wavelength, thereby becoming left circular polarized light (c2). The left circular polarized light (c2) passes through the condensing lens 150 and the nano-aperture 165 of the plasmonic device 160, whereby a near field (E) is generated.

Light (R) reflected (scattered) from the nano-aperture and proceeding backward has the same polarized state as the incident light (c2) and passes through the condensing lens 150. The right circular polarized light (c2′) passes through the phase delay unit 140 to be delayed by a quarter of the wavelength, thereby becoming vertically polarized light (b2′). The vertically polarized light (b2′) arrives the measuring unit 170 through the beam splitter 120 and is used to measure the physical characteristics of the object under test 200.

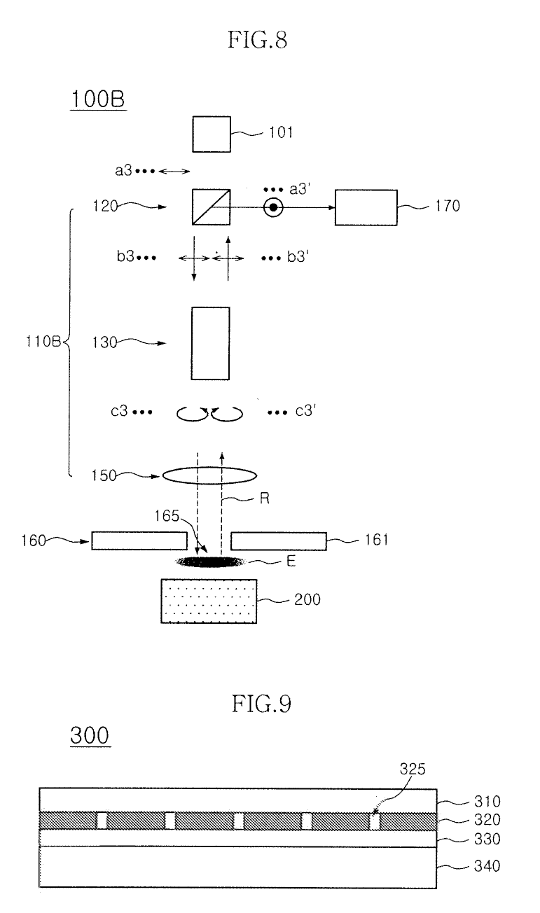

Further, a polarization modulation unit 110B of a measuring apparatus 100B can include a beam splitter 120, a Faraday rotator 130, and a condensing lens 150 as shown in FIG. 8.

In a case where the polarization modulation unit 110B is configured as described above, light (a3) provided from the light source 101 passes through the beam splitter 120, thereby becoming vertically polarized light (b3). The vertically polarized light (b3) passes through the Faraday rotator 130 to be delayed by a quarter of the wavelength, thereby becoming left circular polarized light (c3). The left circular polarized light (c3) irradiates onto the nano-aperture through the condensing lens 150, and a near field (E) is generated in front of the nano-aperture 165.

Then, light reflected from the nano-aperture has the same polarized state as the incident light (c3) and passes through the condensing lens 150. The right circular polarized light (c3′) having passed through the condensing lens 150 and proceeding backward passes through the Faraday rotator 130 to be delayed by a quarter of the wavelength, thereby becoming horizontally polarized light (b3′). In this apparatus, the horizontally polarized light (b3′) proceeding backward is divided by the beam splitter 120 to measure a change in the polarized light generated by the nano-aperture, whereby the light proceeding backward is measured by the measuring unit 170.

Meanwhile, FIG. 9 is a sectional view of a high-density information recording medium using a plasmonic device according to another embodiment.

A high-density information recoding medium 300 can include a passivation layer 310, a thin metal film 320 having nano-apertures 325 disposed at predetermined intervals, a recoding layer 330, and a supporting layer 340.

The passivation layer 310 is disposed on the rear surface of the thin metal film 320, is formed of a material whose non-linear characteristics are variable according to incident light, reduces the strength of a near field generated in front of the nano-apertures 325, and improves the record density. The passivation layer 310 occurs self-focusing in itself, thereby increasing the number of available aperture in an optical system and reducing the diameter of condensed light flux. The passivation layer 310 may be formed of a metal-dielectric compound such as As₂S₃, a-Si, InSb, Cu—SiO₂, Ni—SiO₂, Cu—Ni—SiO₂, and Cu—Al₂O₃, a semiconductor quantum dot dielectric compound material, or a compound material in which a II-IV group compound, or III-V group compound is dispersed in glass or resin.

The thin metal film 320 may be an aluminum film as the plasmonic device, and the thickness thereof may be determined in consideration with, for example, the transmittance and thickness of the recoding layer 330. Further, the apertures 325 of the thin metal film 320 may be designed in consideration with an information layer (not shown) formed in the recoding layer 330 and may have various shapes. In this embodiment, in order to achieve high-density optical record, the apertures 325 may be disposed at intervals of about 100 nm to 200 nm.

In the high-density information recoding medium, the non-linear passivation layer 310 is formed on the thin metal film 320 having the nano-apertures 325 formed therein, and the recoding layer 330 where information is recorded is disposed below the thin metal film 320.

Then, if light is irradiated onto the passivation layer 310, the passivation layer 310 performs self-focusing to primarily reduce the diameter of condensed light flux, and the light flux passes through the nano-apertures 325 to generate a near field, whereby high-density information layers can be formed in the recoding layer 330 at fine intervals.

The apparatus for measuring light proceeding backward can also measure the locations and characteristics of the information layers formed in the recoding layer 330 of the high-density information recoding medium.

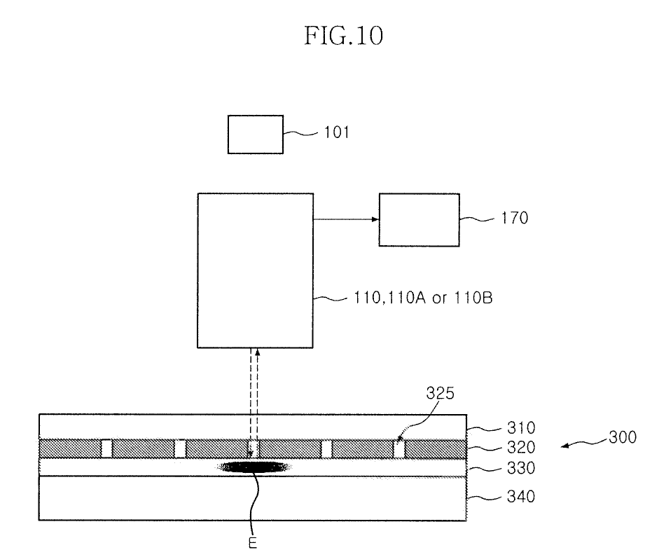

As shown in FIG. 10, the high-density information recoding medium 300 is disposed in front of the apparatus for measuring light proceeding backward which includes the light source 101, the polarization modulation unit 110, 110A, or 110B, and the measuring unit 170. In this case, since the high-density information recoding medium 300 can includes the thin metal film 320 having the nano-apertures 325 formed therein, it is unnecessary to provide a separate plasmonic device between the polarization modulation unit 110, 110A, or 110B and the high-density information recoding medium 300.

The light passed through the polarization modulation unit 110, 110A, or 110B is incident onto the individual nano-apertures 325 of the thin metal film 320 and a near field (E) obtained thereby makes the light proceed backward to the nano-apertures 325 and the polarization modulation unit 110, 110A, or 110B. Therefore, it is possible to measure the characteristics of the recoding layer 330 and the characteristics and locations of the information layers formed in the recoding layer 330.

In this case, in order to measure the light proceeding backward for each of the nano-apertures 325 of the high-density information recoding medium 300, it is possible to read out recorded information while moving the high-density information recoding medium 300.

It will be apparent to those skilled in the art that various modifications and changes may be made without departing from the scope and spirit of the present invention. Therefore, it should be understood that the above embodiments are not limitative, but illustrative in all aspects. The scope of the present invention is defined by the appended claims rather than by the description preceding them, and therefore all changes and modifications that fall within metes and bounds of the claims, or equivalents of such metes and bounds are therefore intended to be embraced by the claims.

What is claimed is:

1. An apparatus for measuring light proceeding backward, the apparatus comprising:
a plasmonic device including a thin metal film having apertures having a nano-sized diameter, disposed close to an object, and generating a near field in front of the aperture;
a polarization modulation unit for adjusting the polarized state of light entering through the apertures of the plasmonic device, and making the light reflecting the strength of the near field proceed into the rear of the nano-apertures of the plasmonic device, and
a measuring unit for detecting properties of the object from the light proceeding backward from the polarization modulation unit,
wherein the strength of the near field generated between the object and the plasmonic device is variable according to the properties of the object.

2. The apparatus of claim 1,
wherein the polarization modulation unit is configured to make the polarized state of the light entering through the apertures of the plasmonic device and the polarized state of the light reflecting the strength of the near field become the same.

3. The apparatus of claim 1,
wherein the polarization modulation unit includes
a beam splitter horizontally polarizing incident light from a light source,
a Faraday rotator delaying the horizontal polarized light having passed through the beam splitter by a quarter of the wavelength, and
a phase delay unit delaying the light having passed through the Faraday rotator by a quarter of the wavelength to generate vertically polarized light.

4. The apparatus of claim 1,
wherein
the polarization modulation unit includes
a beam splitter horizontally polarizing incident light from a light source, and
a Faraday rotator delaying the horizontal polarized light having passed through the beam splitter by a quarter of the wavelength.

5. The apparatus of claim 1,
wherein the polarization modulation unit includes
a beam splitter horizontally polarizing incident light from a light source, and
a phase delay unit delaying the horizontal polarized light having passed through the beam splitter by a quarter of the wavelength.

6. The apparatus of any one of claims 1,
wherein the polarization modulation unit further includes a condensing lens condensing light whose polarized state has been modulated into the plasmonic device.

7. An apparatus for measuring light proceeding backward, the apparatus comprising:
a polarization modulation unit adjusting the polarized state of light entering an object, and making light reflected from the object proceed backward, and
a measuring unit detecting properties of the object from the light proceeding backward from the polarization modulation unit,
wherein the object includes a built-in plasmonic device composed of a thin metal film having apertures having a nano-sized diameter formed therein, and
the strength of the near field generated between the object and the plasmonic device is variable according to the properties of the object.

8. The apparatus of claim 7, wherein:
the object includes
a non-linear passivation layer reducing the diameter of a light flux of the incident light,
a plasmonic device disposed below the non-linear passivation layer and composed of a thin metal film having apertures at predetermined intervals of several to several tens of nano-meters, and
a recoding layer disposed below the plasmonic device where information is recorded by light transmitted through the apertures.
